(19) United States
(12) Patent Application Publication
(10) Pub. No.: US 2010/0017078 A1
(43) Pub. Date: Jan. 21, 2010

(54) METHOD FOR CONTROLLING AN AUTOMATED VEHICLE CHANGE-SPEED GEARBOX

(75) Inventors: Rainer Petzold, Friedrichshafen (DE); Mario Steinborn, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/446,585

(22) PCT Filed: Oct. 11, 2007
(86) PCT No.: PCT/EP07/60805

§ 371 Date: Apr. 22, 2009

(30) Foreign Application Priority Data
Oct. 24, 2006 (DE) 10 2006 050 006.7

(51) Int. Cl. F16H 61/12; G06F 19/00

(52) U.S. Cl. 701/52

(57) ABSTRACT

A method for controlling an automated vehicle transmission during the process of starting such that a gear is selected, depending on predetermined criteria, and engaged by a transmission control device. For maintaining the availability of the vehicle, so far as possible, even if there is a failure in the gearshift system, the method provides that if a gear preselected by the driver or by a starting strategy system should fail, a substitute gear is engaged automatically. To give the driver enough time to react appropriately to the unexpected starting situation, a delayed starting sequence (substitute starting mode), which is implemented by an electronic vehicle control system, is independent of the dynamics of accelerator pedal actuation.

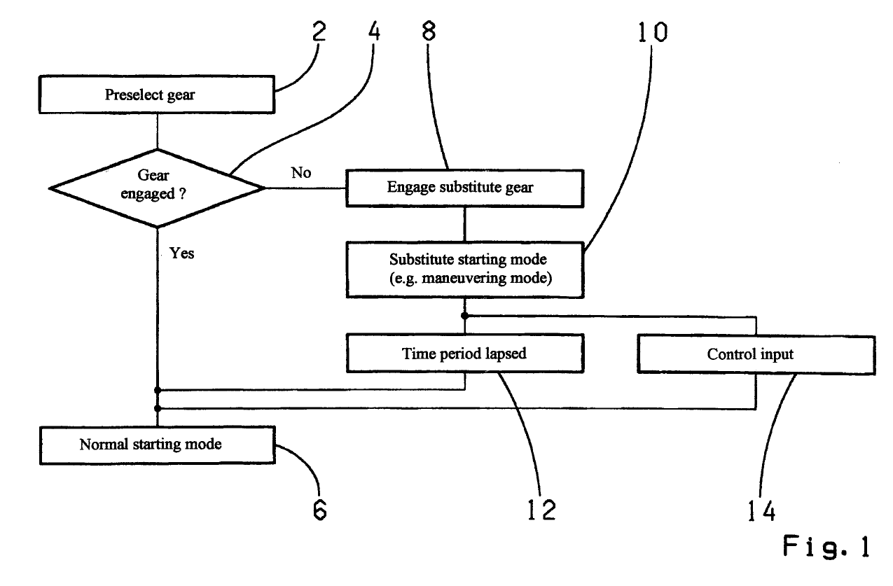

This application is a National Stage completion of PCT/EP2007/060805 filed Oct. 11, 2007, which claims priority from German patent application serial no. 10 2006 050 006.7 filed Oct. 24, 2006.

### FIELD OF THE INVENTION

The invention concerns a method for controlling an automated vehicle manual transmission.

### BACKGROUND OF THE INVENTION

Automated vehicle manual transmissions offer among other things the possibility of selecting and engaging a gear suitable for the actual start-off process, by means of a transmission control device. For example, in the case of heavy utility vehicles with multi-gear range-change transmissions various gears are suitable for starting off, of which one gear is selected as the start-off gear depending on the load and the driving situation.

Thus, from EP 1 112 455 B1 a method is known, in which the specified criteria include at least the mass of the vehicle and a magnitude that characterizes the climbing resistance of the vehicle, and such that, in addition, a maximum acceptable value for a clutch slipping time and/or a maximum acceptable value for the friction work of the starting clutch during the start-off process, as well as an engine torque available for starting off, are taken into account. The known method also envisages testing the criteria first for a highest gear suitable for starting off, and if the criteria are not fulfilled, then continuing this testing process with the next-lower gear, etc., until a gear is found in which the criteria are fulfilled and the gear suitable for starting off has therefore been identified. This gear can then be automatically engaged.

A possible cause of error in automated manual transmissions is that because of failures in the system, i.e. due to mechanical or electrical faults or because of wrong signals of the starting gear selected by the driver by a start-off strategy system, which can also determine the driving direction, no shift can be carried out. A quite general requirement is that the availability of the vehicle should be maintained so far as possible. This means that when the vehicle is capable of starting in a purely technical sense, this should also be made possible in practice. The above-mentioned patent provides no solution for such a case.

### SUMMARY OF THE INVENTION

Against that background the purpose of the present invention is to provide a control method, which ensures the greatest possible vehicle availability even in the event of a system fault of the type described above.

The invention is based on the recognition that the ability of the transmission control device to automatically select a suitable start-off gear and where appropriate engage it, should also be usable in cases when a preselected starting gear cannot be engaged because of faults in the system.

Accordingly, the invention begins with a method for controlling an automated vehicle manual transmission during a starting process, in which a gear is selected and engaged by a transmission control device as a function of predetermined criteria.

To achieve the stated objective provision is made, during this, for the event that if a gear preselected by the driver or by a starting strategy system should fail, a substitute gear is automatically engaged.

However, first of all for the driver this results in an unexpected departure from the customary and expected starting behavior. Compared with the gear originally envisaged the substitute gear may be different in the following ways:
gear too high,
gear too low,
gear operates in the driving direction opposite to the one chosen,
a gear is engaged despite the neutral position having been preselected.

To prevent the automatic system reaction from putting the driver of the vehicle in a critical driving situation which he cannot control, according to another characteristic of the invention it is provided that after the engagement of a substitute gear, a delayed start-off sequence (substitute starting mode) independent of the dynamics of an accelerator pedal actuation is implemented by an electronic vehicle control system.

The substitute starting mode gives the driver enough time to react in an appropriate manner to the—for him unexpected—starting behavior of the vehicle, for example by letting up the accelerator or by depressing it to a specific extent, as described in more detail later on.

If the vehicle control system comprises a maneuvering mode known per se, in which the speed of the vehicle is restricted, then according to another feature of the invention the maneuvering mode is actuated as the substitute starting mode.

According to a further feature of the invention the substitute starting mode provides for a slow torque build-up, regulated by the vehicle control system, with little or no movement of the vehicle, so that the driver can recognize the tendency of the expected vehicle movement and react promptly in an appropriate manner.

Another feature of the invention provides that in the substitute starting mode torque fluctuations are produced in the drivetrain, which warn the driver that the preselected gear is not available. For example the torque fluctuations can be produced by pulsed accelerator actuation with the starting clutch engaged, or by alternate engagement and disengagement of the starting clutch while the fuel feed remains constant.

In general it is sufficient for the substitute starting mode to be maintained for a certain period, which gives the driver enough time to react in an appropriate manner to the unexpected starting situation. Such a time period can have a fixed value, or its length can vary depending on the operating situation. The time period may for example be between 1 and 5 seconds. If the substitute gear engaged does not correspond to the driving direction selected, the longest time period is to be preferred, this period being recognized by a driver as longer than with a substitute gear that corresponds to the preselected driving direction.

Accordingly, the invention provides that the substitute starting mode ends after the lapse of a predetermined time and is changed to a normal starting mode in which, for example, the vehicle again reacts in the usual way to accelerator pedal actuation.

According to another feature of the invention it can be provided that the substitute starting mode is terminated by a manual control input by the driver and the change to a normal starting mode takes place. The control input can be, for example, an accelerator pedal release or a full depression of the accelerator pedal to trigger a kick-down signal, or in a different version of the invention, by preselecting a new gear.

### BRIEF DESCRIPTION OF THE DRAWING

The invention can be explained further with reference to an example embodiment. For this purpose the specification includes a drawing which shows a sequence diagram of the method according to the invention.

### DETAILED DESCRIPTION OF THE PREFERRED EMBODIMENTS

With reference to the sequence diagram a concrete example will be described in Step 2 a starting gear is preselected. By the driver or a start-off strategy system stored in a transmission control device. In Step 4 it is determined whether the gear has been engaged or not. If the gear has been engaged, the process continues in the normal starting mode at Step 6.

If in Step 4 it is found that the preselected gear has not been engaged, the transmission control device selects and engages a suitable gear. During this it can even happen that, for example if the reverse driving direction was selected, a forward gear is selected and engaged as the substitute gear. This case is particularly critical, so the driver must be given enough time to adjust to the unexpected situation and react to it as necessary.

After the selection and engagement of the substitute gear, in Step 10 a substitute starting mode is implemented in which, in each case, a delayed starting sequence independent of the dynamics of an accelerator pedal actuation takes place. The substitute starting mode is terminated either in Step 12 after the lapse of a predetermined time, or as in Step 14 by a control input from the driver, and the normal starting mode 6 is resumed, in which, for example, the vehicle reacts in the normal way to an accelerator pedal actuation.

1-11. (canceled)

12. A method for controlling an automated vehicle manual transmission during a process of starting such that a gear is selected, as a function of predetermined criteria, and engaged by a transmission control device,
the method comprising the steps of:
if a gear, preselected by either a driver or by a starting strategy system should fail, automatically engaging a substitute gear, and thereafter,
implementing a substitute starting mode, independent of dynamics of accelerator pedal actuation, by an electronic vehicle control system.

13. The method according to claim 12, further comprising the step of correlating the substitute starting mode to a predetermined maneuvering mode.

14. The method according to claim 12, further comprising the step of slowly increasing torque in the substitute starting mode with little or no movement of the vehicle.

15. The method according to claim 12, further comprising the step of producing torque fluctuation in a drive train in the substitute starting mode.

16. The method according to claim 15, further comprising the step of producing the torque fluctuation by pulsing accelerator actuation with a starting clutch engaged.

17. The method according to claim 15, further comprising the step of producing the torque fluctuation by alternately engaging and disengaging a starting clutch while a fuel feed remains constant.

18. The method according to claim 12, further comprising the steps of terminating the substitute starting mode, after a lapse of a predetermined time period, and then resuming a normal starting mode.

19. The method according to claim 18, further comprising the step of extending a duration of the predetermined time period, if the substitute gear does not correspond to the preselected driving direction, such that the extended time period is recognizably longer for the driver than with a substitute gear that does correspond to the preselected driving direction.

20. The method according to claim 12, further comprising the steps of terminating the substitute starting mode, via a control input from the driver, and then resuming a normal starting mode.

21. The method according to claim 20, further comprising the steps of terminating the substitute starting mode, when the driver preselects a new gear, and then resuming a normal starting mode.

22. The method according to claim 20, further comprising the steps of terminating the substitute starting mode by either decelerating or pressing the accelerator pedal until a kick-down signal is produced, and then resuming a normal starting mode.

23. A method of controlling an automated manual transmission of a vehicle during a process of starting, the method comprising the steps of:
preselecting a starting gear either manually by driver intervention or automatically by a starting strategy system;
determining an engagement status of the preselected starting gear;
continuing the process of starting off in a regular starting mode, if the preselected starting gear is determined to be engaged;
automatically selecting and engaging a substitute starting gear with a transmission control device, if the preselected starting gear is determined to be disengaged;
implementing, with an electronic vehicle control system, the process of starting off in a substitute starting mode, which independent of dynamics of accelerator pedal actuation and selecting a substitute starting gear; and
allowing a time period to lapse or manually terminating the substitute starting mode and reinitiating the process of starting in the regular starting mode with the substitute starting gear.
